(19) United States
(12) Patent Application Publication
(10) Pub. No.: US 2006/0106327 A1
(43) Pub. Date: May 18, 2006

(54) Vibrator

(76) Inventors: Jorg Thielen, Oberhausen (DE); Andreas Stanislaus Pieronczyk, Oberhausen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/519,702

(22) PCT Filed: Jun. 30, 2003
(86) PCT No.: PCT/EP03/06918

§ 371 Date: Sep. 13, 2005

(30) Foreign Application Priority Data
Jun. 28, 2002 (DE) 102 29 264.7

(51) Int. Cl. A61H 1/00

(52) U.S. Cl. 601/46; 600/38

(57) ABSTRACT

The invention relates to a vibrator (1) for several stimulation, comprising at least one device (2) for generating vibrations. According to the invention, the vibrator (1) can be placed and/or fastened onto a penis (12), in particular the penis tip (13). The invention also relates to a condom, the tip of which is equipped with at least one device (2) for generating vibrations.

### The invention relates to a vibrator for sexual stimulation, having a device for producing vibrations.

Such vibrators are known in many forms as “sex toys.” They are comprised mainly of a generally phallus-shaped device that has a vibrating mechanism that imparts mechanical vibrations to it. It is also known to shape such vibrators exactly like a standard human penis.

Such vibrators and the vibrations and/or movements of them serve to stimulate erotic zones, in particular of the female, to which end the phallus-shaped vibrator is applied to or inserted into the female organ. Thus in particular a female uses such a vibrator as a penis replacement for self-stimulation.

The disadvantage is that such vibrators as a result of their shape are not suitable to stimulate the male erotic zones and thus are not really suitable for sex play for a couple. In particular during actual sexual intercourse the vibrator cannot be used as an additional stimulation aid.

It is therefore an object of the present invention to provide a vibrator that can sexually stimulate a male and also two persons engaged in sexual intercourse.

This object is attained according to the invention in that the vibrator can be fitted to the penis of a male, in particular on the penis tip.

As a result of being able to fit the vibrator according to the invention to the tip of a penis, the male can also be sexually stimulated by its vibration and/or oscillations. It is particularly advantageous that during sexual intercourse the male can insert such a vibrator with the penis into the female organ, so that during sexual intercourse both partners are additionally stimulated by the vibrations and/or movements of the vibrator according to the invention.

With a vibrator according to the invention it is preferred that it can be secured to a penis, in particular on the tip of the penis, so as to avoid that during sexual intercourse the vibrator gets detached from the penis.

Thus in a simple embodiment, the vibrator is fitted to the penis tip and then the vibrator and penis are fitted in a condom that holds the vibrator in place.

For alternative or additional retention, a preferred embodiment provides for example that the vibrator has an outer end forming the tip of the vibrator and holding in particular at least one device for producing vibrations and a middle region that fits on a penis, in particular on a penis tip.

The outer end has the shape of a standard vibrator, forming thus an artificial penis tip. The middle region is hollow and forms a cavity that fits over the penis, or at least the penis tip, e.g. the glans.

It is possible that the cross-sectional size of the opening is smaller than the cross-sectional size of the middle region that holds at least the penis tip so that for example there is good gripping of the glans of the penis since the penis shaft normally is of smaller cross-sectional size than the glans. In addition a condom can be used over everything.

Also alternatively to or in combination with the above-described system, at least the middle region of the vibrator and if necessary the entire vibrator and in particular the surface of the middle region engaging the penis are made of an elastic material that conforms to the outer shape of the penis and/or the penis tip.

Preferred materials are known to the person skilled in the art. For example, latex, silicone, rubber, polyurethane, or any other biologically compatible elastic material can be used.

Thus in a preferred manner between the penis, in particular the penis tip, and in particular the glans, the vibrator or its middle region have a shape that ensure secure retention.

In order to make such retention optimal, it is possible that the middle region has a standard shape imparted to it by molding a hardenable mas individually on a penis or glans.

In a further embodiment it is possible that the middle region is hollow and has at the tip of the vibrator a recess in particular serving as reservoir for ejaculate, as known in a condom.

In this case it is particularly advantageous when the vibrator is made of elastic material to use the pressure of this recess or reservoir created when air is forced out of it and thus to create a suction effect that retains the vibrator on the penis. This effect is further automatically eliminated when the reservoir is filled with ejaculate.

With the exemplary above-described features a secure retention of the vibrator on the penis tip or glans is ensured so that the vibrator can also be made very small.

In an alternative or further embodiment the middle region of the vibrator can be extensible or extended from the penis tip over at least a portion of the penis shaft.

Thus for example the middle region of the vibrator has a hollow shape formed for example unitarily of elastic material, in particular to completely contain the penis. This hollow shape can for example be tubular and for example the same as or similar to the shape of a penis. It is also possible that reinforcements extend along the middle region lengthwise of the penis shaft and contain the penis and thus ensure secure retention. The hollow shape and/or reinforcements can also be movable, e.g. telescopable, in order to slide over the penis when the vibrator is fitted.

In an alternative embodiment it is possible that the middle region is provided with a rolled-up sheath or elastic tube that can be pulled and/or unrolled over the penis. Such a construction is known from condoms where the elastic sheath or tube is rolled up into a ring and thus the condom sleeve can be rolled down over the penis in order to fully contain it. Such a vibrator is also very securely retained by the elastic interfit between the sheath and the penis. Such a vibrator makes it possible to practice “safe sex.”

According to a further specific preferred embodiment the system of this invention is made generally as a condom, with the condom tip holding an apparatus for producing vibrations.

Both with the vibrator and with the condom according to the invention it is preferred that either the open end of the elastic hollow body or the open end of the condom is provided with another device for producing vibrations, in particular in a holder ring that engages around the base of the penis. Such vibratory devices can be put at any location on the vibrator, for example in a second region in the hollow part, in the reinforcements, or elsewhere.

To this end the device for producing vibrations is fitted in a thickened region of for example a ring surrounding the penis at the open end of the vibrator/condom where there sufficient room for installing the vibratory device. It is also possible to increase the thickness of the ring from the ring plane parallel to the penis forward. Preferably the ring and the thickened part are positioned such that the thickened part and the internally mounted vibratory device lie on the upper side of the penis and thus can be juxtaposed with the clitoris of the female organ. The ring itself can be made elastic and/or adjustable in its diameter so as to retain blood in the penis shaft. This ring can also if desired have several vibratory devices, for example in thickened regions. These vibrator device can for example be distributed about the periphery of the ring. It is also possible that vibratory device be removably mounted on the holder ring. e.g. clipped thereto it in various positions.

With this additional vibratory device and the particular shape it is possible during sexual intercourse to particularly stimulate the female's erotic regions, in particular the clitoris.

A device for producing vibrations can include a vibratory motor and for example also an energy source. In particular an electrical motor can be used that produces vibrations or another movements and that for example is powered by a battery or the like.

How long the vibrations are produced depends from the capacity of the energy source, which is not normally a problem when the vibrator or condom according to the invention with vibration is supplied for single use.

When the vibrator is to be reused, the energy source should be replaceable and/or rechargeable. Thus for example an electrical connection for loading a rechargeable battery can be provided or a closable opening on the vibrator tip or ring through which the energy source can be removed and replaced.

It is particularly advantageous when the vibrator or condom and the vibratory device or devices therein have a switch for turning on and/or off the vibratory motor.

Such a switch can for example have a button that for example is actuatable through the elastic material so that for example a finger can turn the vibrations on or off. It is also possible that the switch be pressure- and/or motion-sensitive so that the turning on and/or off can be dependent of the people using it.

In a further alternative it is possible that the switch be temperature-sensitive so that the device for producing vibrations be turned on and/or off in accordance with temperature when the vibrator, condom or the vibratory device or its temperature-sensitive element is heated for example to body temperature around 35-37° C. It turns off at a lower temperature. The vibrations will also start for example shortly after the vibrator/condom is put on and ends shortly after it is taken off as a result of the changing temperature. This can be done in a particularly simple manner by a bimetallic switch.

To avoid damage when the users move, the device for producing vibrations is enclosed in a protective case, in addition or alternatively to the elastic material that surrounds it.

Embodiments of the invention are shown in the attached drawing in which:

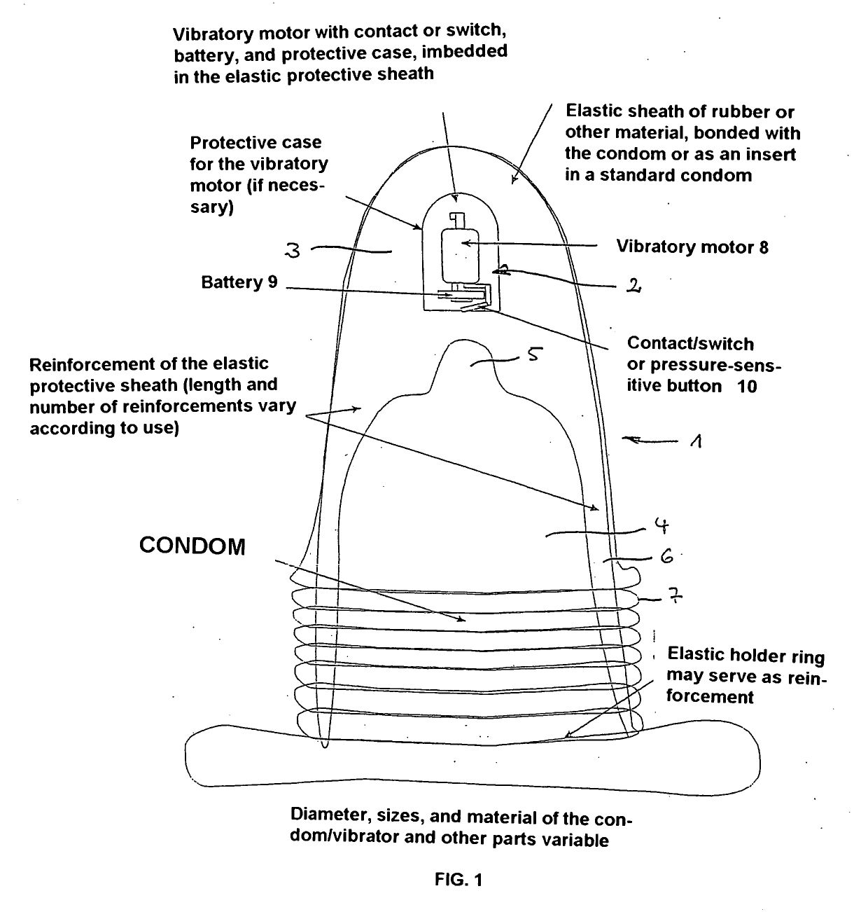

FIG. 1 is a vibrator according to the invention fittable to a penis and also surrounded by a condom;

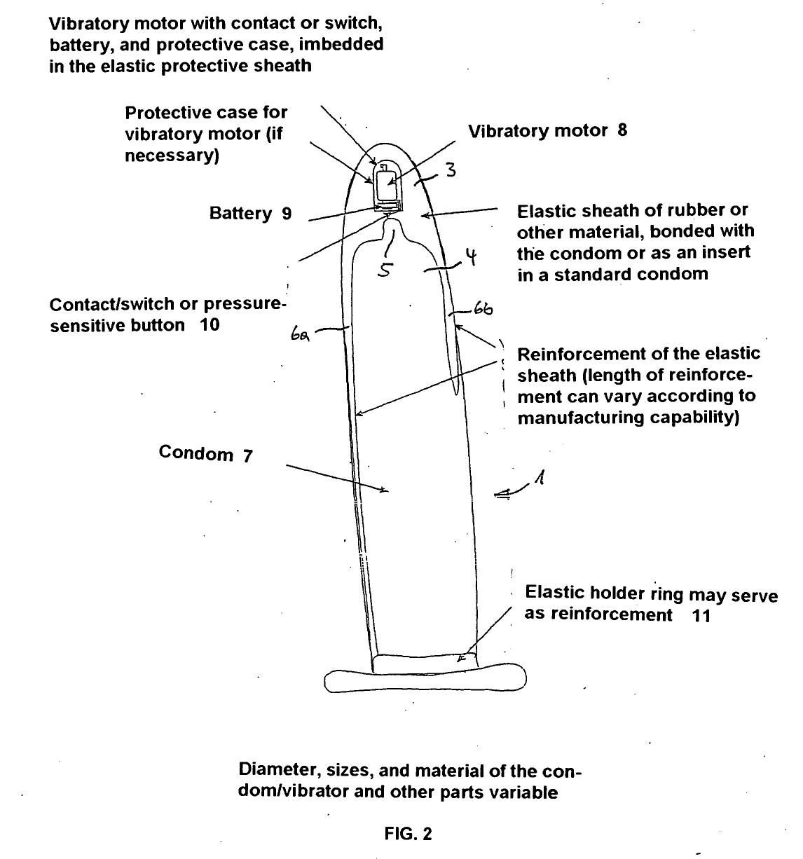

FIG. 2 is a vibrator according to the invention fittable to a penis, with integral reinforcement and holder ring;

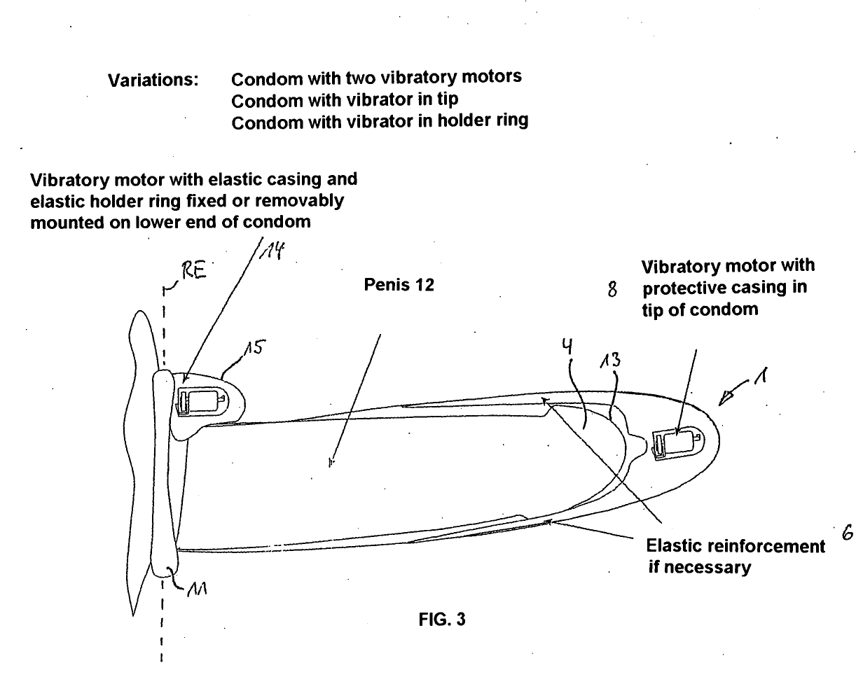

FIG. 3 is a vibrator as in FIG. 2 with a second vibrating device at the open end on the holder ring.

FIG. 1 shows a vibrator 1 according to the invention that is fittable on a penis not illustrated here. The vibrator 1 has an outer end 3 that forms the tip of the vibrator and thus an artificial penis tip and which holds the device 2 for producing vibrations. This device 2 is completely contained by the outer end so that the outer end also serves to protect the vibrating device 2.

Rearward of the outer end 3 is a middle region 4 that is hollow and that serves to hold the penis, at least the penis tip. This middle region 4 and the end 3 can be made of an elastic material. e.g. latex, rubber, PU, or the like, in order to ensure a comfortable and secure fit to the penis.

The middle hollow region 4 forms a cavity 5 that can serve as a reservoir for ejaculate and that can also exert a suction effect on the penis tip.

The hollow region 4 is provided with reinforcements 6 that extend at least over part of the penis so as to ensure a secure fit and mount.

The outer end 3 of the vibrator 1 holds the vibrating device that in this case, for example, is imbedded in elastic material and has a vibratory drive or motor 8 with an energy source, e.g. a battery 9.

The electrical connection between the battery 9 and the vibratory motor 8 can be made by a switch 10 that is here set underneath the vibratory motor 8. This switch can be tripped by pressure toward the tip at the inner end of the hollow region 4. Thus for example the switch can be actuated, e.g. by a fingertip, before fitting the vibrator to a penis or can be actually actuated by the penis tip itself which pushes when in place on the switch 10. Thus the switch 10 can be actuated by movement.

In this embodiment the vibrator is also fitted inside a condom 7 to ensure “safe sex” and to also securely retain the vibrator on the penis.

An unillustrated possibility is the formation of the condom sheath or tube unitarily with the vibrator or its middle region 4 so that in this manner a condom is formed which has the vibratory drive in its tip. Here the condom sheath 7 can in starting unused condition be rolled up or gathered.

The embodiment of FIG. 2 is similar to that of FIG. 1. Here also the outer end 3 formed as an extension of the middle region 4 of the vibrator has reinforcements 6 that extend around and along the length of the penis. This reinforcement need not be all around, but can instead be formed as strips 6 that have different lengths to more or less cover the penis.

At least one of the formations 6 can extend to the end of the vibrator and merge with a reinforcement and/or holder ring 11 that is also formed of an elastic material in order to ensure secure retention of the vibrator on the base of the penis.

Here a condom 7 can also be used with the vibrator, so that when unrolled it contains the vibrator 1 and the penis.

FIG. 3 shows a vibrator according to the invention that is set on a schematically shown penis 12. One can here see that the glans 13 of the penis 12 fits in the middle region 4 of the vibrator. The elastic material inside the middle region 4 can tightly fit to the glans to ensure secure retention.

In addition the holder ring 11 win this embodiment has a second device that produces vibrations and that can be made like the vibrating device in the tip of the vibrator.

The vibrating device 14 of the holder ring 11 is provided in a thickened region 15 of the holder ring that has sufficient room for the motor and the energy source. The thickened region 15 is unitarily formed with the holder ring and extends forwardly from a ring plane RE toward the tip of the vibrator I so that this thickened region is so positioned that when aligned with the upper side of the penis 12 it produces particularly effective stimulation of the clitoris during sexual intercourse.

On the side of the thickened region turned toward the male, that is the rear surface of the holder ring there can be an unillustrated opening that gives access to the battery in order to be able to change it. This can also contain an electrical connection for charging it.

In this embodiment the diameter of the ring can be varied in order to allow the venous blood flow necessary for the male erection.

With such a vibrator according to the invention it is possible to stimulate both partners during sexual intercourse.

1-16. (canceled)

17. A vibrator comprising:
an elastomeric sheath having a closed front end and an open rear end and shaped to fit over at least a tip of a human penis;
a battery in the sheath;
a vibratory drive in the sheath; and
a switch imbedded in the sheath, connected between the battery and the drive, and actuatable through the sheath into an on position energizing the drive from the battery to vibrate a portion of the sheath.

18. The vibrator defined in claim 17 wherein the vibratory drive is imbedded in the closed front end of the sheath.

19. The vibrator defined in claim 18 wherein the sheath is centered on a longitudinal axis and forms an axially rearwardly open cavity.

20. The vibrator defined in claim 19 wherein the closed front end of the sheath is formed rearward of the drive with a rearwardly open reservoir.

21. The vibrator defined in claim 19 wherein the sheath is formed with a thin-walled, flexible, and tubular skirt extending rearward of the closed front end.

22. The vibrator defined in claim 21 wherein the skirt can be rolled up.

23. The vibrator defined in claim 19, further comprising a condom fittable over the sheath and extending rearward past the open rear end of the sheath.

24. The vibrator defined in claim 19 wherein the sheath is formed rearward of the closed front end as a condom.

25. The vibrator defined in claim 19, wherein the sheath is formed with an openable flap through which the battery is accessible and removable.

26. The vibrator defined in claim 18, further comprising
a second vibratory drive imbedded in the sheath adjacent the open end thereof.

27. The vibrator defined in claim 26 wherein the sheath is formed at the open rear end with a ring having a thickened region in which the second vibratory drive is imbedded.
